(19) United States
(12) Patent Application Publication
(10) Pub. No.: US 2016/0355052 A1
(43) Pub. Date: Dec. 8, 2016

(54) DEVICE FOR CLEANING A PAINT ROLLER

(71) Applicant: Carlos Vasquez, San Diego, CA (US)

(72) Inventor: Carlos Vasquez, San Diego, CA (US)

(21) Appl. No.: 15/173,003

(22) Filed: Jun. 3, 2016

Related U.S. Application Data
(63) Continuation of application No. 14/022,226, filed on Sep. 10, 2013, now abandoned.

(51) Int. Cl. B44D 3/00; B08B 1/00; B08B 3/02; B05C 17/02

(52) U.S. Cl. CPC B44D 3/006; B05C 17/0245; B08B 1/005; B08B 3/02

(57) ABSTRACT

A device for cleaning a paint roller or other device is provided. The device includes an outer ring wall and an inner ring wall integrally connected to and located within the outer ring wall defining an opening for receiving an object. A plurality of holes is arranged in a circle on the inner ring wall for propelling liquid in a forward direction into the object. The device further includes a handle member integrally connected to and extending perpendicularly outward from the outer ring wall, the handle member adapted to be matingly engaged with a hose, the hose supplying the liquid to the plurality of holes. The handle member includes a hand grip portion and a trigger portion pivotally attached or coupled to the hand grip portion, the trigger portion adapted for movement between a no flow position and an open position.

### CLAIM OF PRIORITY

The present Application for Patent claims priority to U.S. Provisional Application No. 61/699,848 entitled “Device for Cleaning a Paint Roller”, filed Sep. 11, 2012, which is hereby expressly incorporated by reference.

### FIELD

Various features relate to devices for cleaning paint rollers.

### BACKGROUND

Paint rollers are typically used for painting large flat surfaces rapidly and efficiently. The roller absorbs the paint and transfers it to the surface. To maintain the quality and durability of the roller, when painting is completed for the day, the paint-carrying surface of the roller must cleaned or else the paint will dry on the roller rendering it useless for further painting. As rollers used by professional painters can be expensive, it is cost-effective to clean each roller after it has been used.

Paint rollers are typically cleaned by placing the roller on the edge of the pain can and using a putty knife to scrape the paint off the roller into the paint can. The roller must be turned each time it is scraped to ensure as much paint is removed from the entire surface area of the roller as possible. The remaining paint is then washed off with pater and the roller is allowed to air dry.

Other methods of cleaning rollers involve spraying water from a hose, such as a garden hose, at the roller. This method is haphazard, messy, and fails to clean every part of the paint-carrying surface. Additionally, this method is wasteful of water as only some of the water comes into contact with the roller and a big percentage of the water shoots away from the roller, making the roller spin, splashing watered paint in every direction causing a messy and environmentally hazardous situation.

In view of the foregoing, what is needed is a device for cleaning paint rollers that use less water, prevents the watered paint from splashing in every direction, and is time efficient for a painter/contractor to use.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one feature, a cleaning device is provided. The cleaning device includes an outer ring wall; an inner ring wall integrally connected to and located within the outer ring wall defining an opening for receiving an object, such as a paint roller; a plurality of holes arranged in a circle on the inner ring wall for propelling liquid in a forward direction into the object; and a handle member integrally connected to and extending perpendicularly outward from the outer ring wall, the handle member adapted to be matingly engaged with a hose, the hose supplying the liquid to the plurality of holes.

The handle member includes a hand grip portion; and a trigger portion pivotally attached or coupled to the hand grip portion, the trigger portion adapted for movement between a no flow position and an open position. When the trigger portion is in the open position, fluid flows to the inner ring wall and propels out the plurality of holes.

The hand grip portion, having a top portion and an opposite bottom portion, includes a first protrusion extending perpendicularly outward from the top portion; a second protrusion extending perpendicularly outward from the top portion, the second protrusion located parallel to and below the first protrusion in the same vertical plane; and a receptacle located at the bottom portion in the same vertical plane as the first and second protrusions. The first and second protrusions may be separated by a distance and adapted to receive a first end of a second object; and wherein the receptacle is adapted to receive a second end of the second object, such as a paint can opener.

The cleaning device may further include a flow control knob, connected to the hand grip portion for adjusting the amount and force of fluid that is propelled out of the plurality of holes, and one or more scraping attachments secured to, and extending outwardly from, the outer ring wall. The one or more scraping attachments have an outer edge having a convex configuration.

The cleaning device may further include a trigger locking bar secured to the bottom portion of the hand grip portion, the trigger locking bar moveable between a locked position and an unlocked position; and a locking groove located at an end portion of the trigger portion. When in the locked position, the locking trigger bar is received within the locking groove locking the trigger portion in the open position and when in the unlocked position the locking trigger bar is released from the locking groove and the trigger portion is in the no flow position.

According to another feature, a cleaning device is provided. The cleaning device comprises an outer ring wall; one or more scraping attachments secured to, and extending outwardly from, the outer ring wall; an inner ring wall integrally connected to and located within the outer ring wall defining an opening for receiving an object; a plurality of holes arranged in a circle on the inner ring wall for propelling liquid in a forward direction into the object; and a handle member integrally connected to and extending perpendicularly outward from the outer ring wall, the handle member adapted to be matingly engaged with a hose for supplying the liquid to the plurality of holes. The hand member includes a hand grip portion; and a trigger portion pivotally attached or coupled to the hand grip portion, the trigger portion adapted for movement between a no flow position and an open position. The cleaning device may further include a flow control knob connected to the hand grip portion for adjusting the amount and force of fluid that is propelled out of the plurality of holes.

### BRIEF DESCRIPTION OF THE DRAWINGS

FIG. 1 illustrates a side view of a cleaning device, according to one embodiment.

FIG. 2 illustrates of a side perspective view of a cleaning device, according to one embodiment.

FIG. 3 is a cross sectional view of the cleaning device of FIG. 1.

FIG. 4 illustrates a side perspective view of a cleaning device with a paint roller inserted therein, according to one embodiment.

### DETAILED DESCRIPTION

The following detailed description is of the best currently contemplated modes of carrying out the invention. The description is not to be taken in a limiting sense, but is made merely for the purpose of illustrating the general principles of the invention. Furthermore, in the following description, specific details are given to provide a thorough understanding of the embodiments. However, it will be understood by one of ordinary skill in the art that the embodiments may be practiced without these specific details.

While the present invention is described primarily with respect to the cleaning of paint rollers, the present invention may be applied and adapted to cleaning of other objects such as paint brushes.

In the following description, certain terminology is used to describe certain features of one or more embodiments of the invention. The term “fluid” refers to water or any other type of liquid cleaning solution that may be used for washing paint off an object.

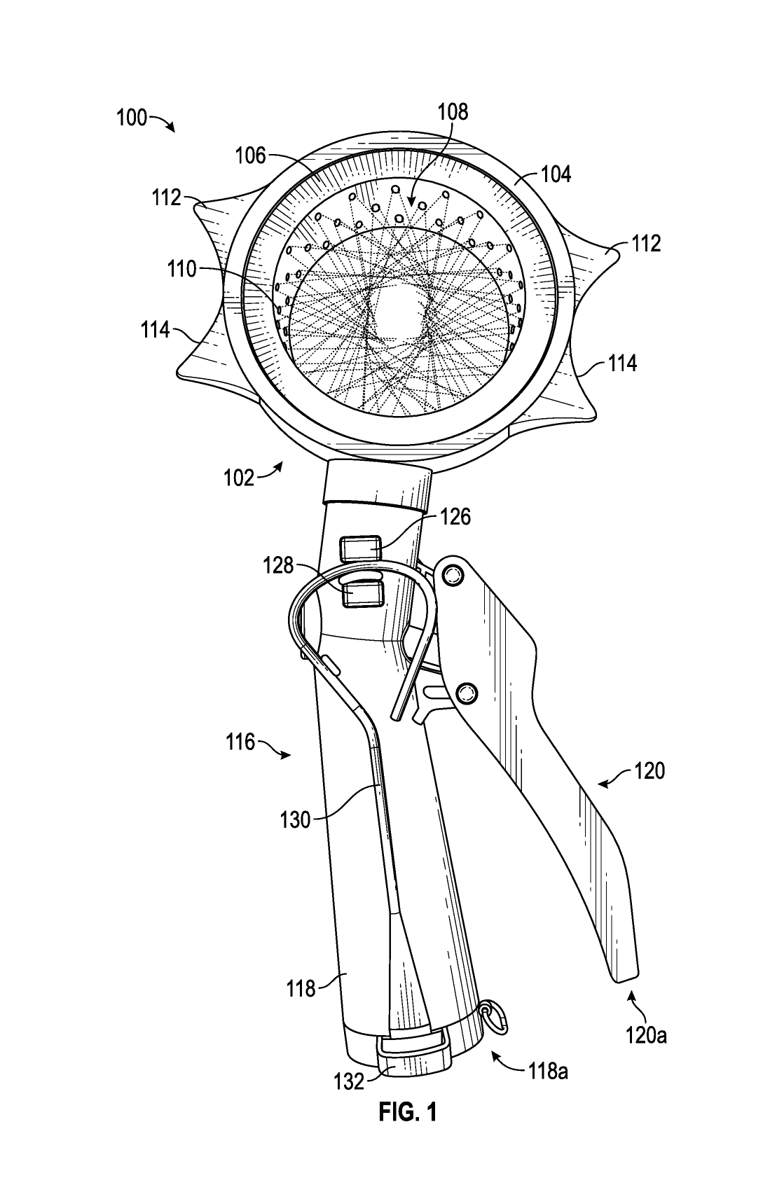

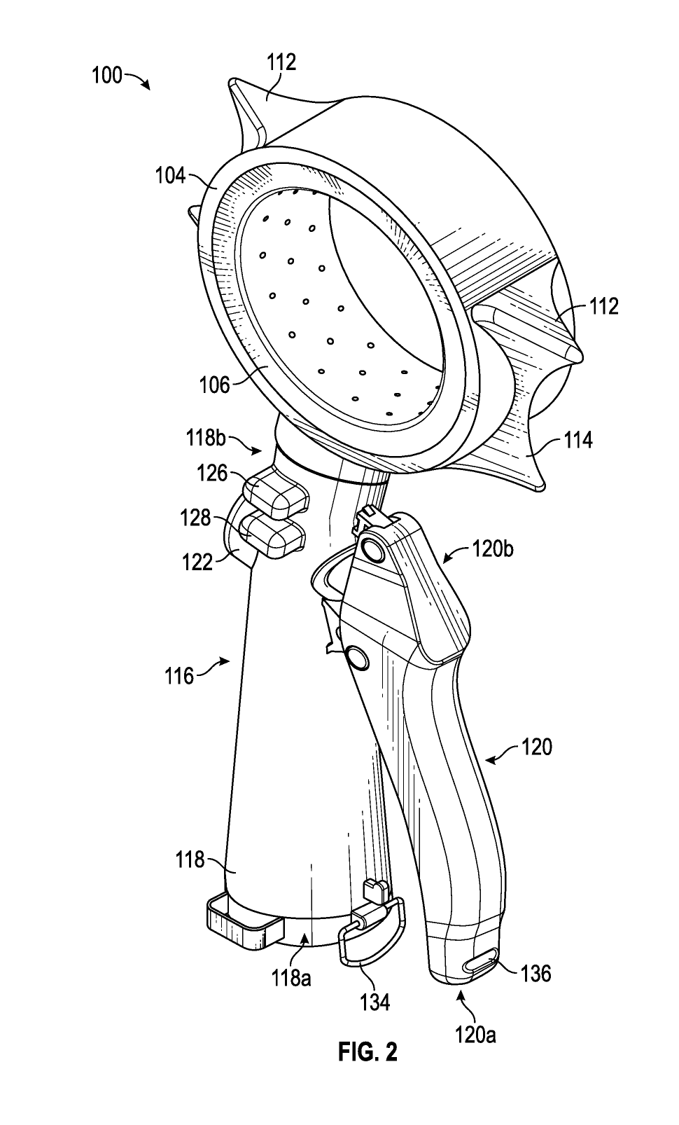

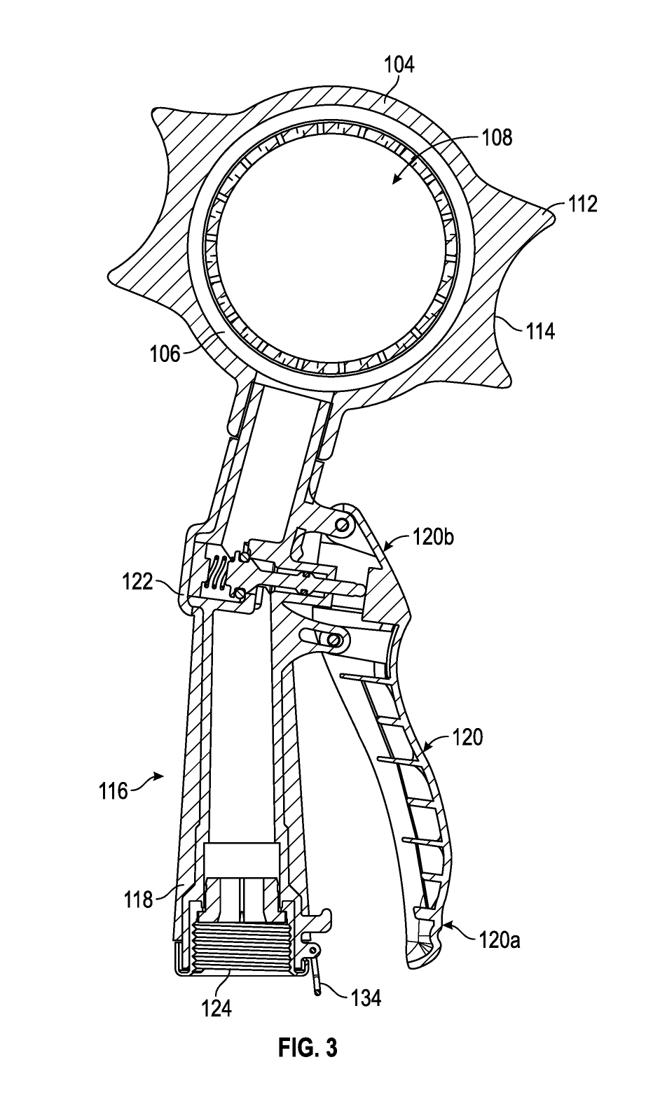

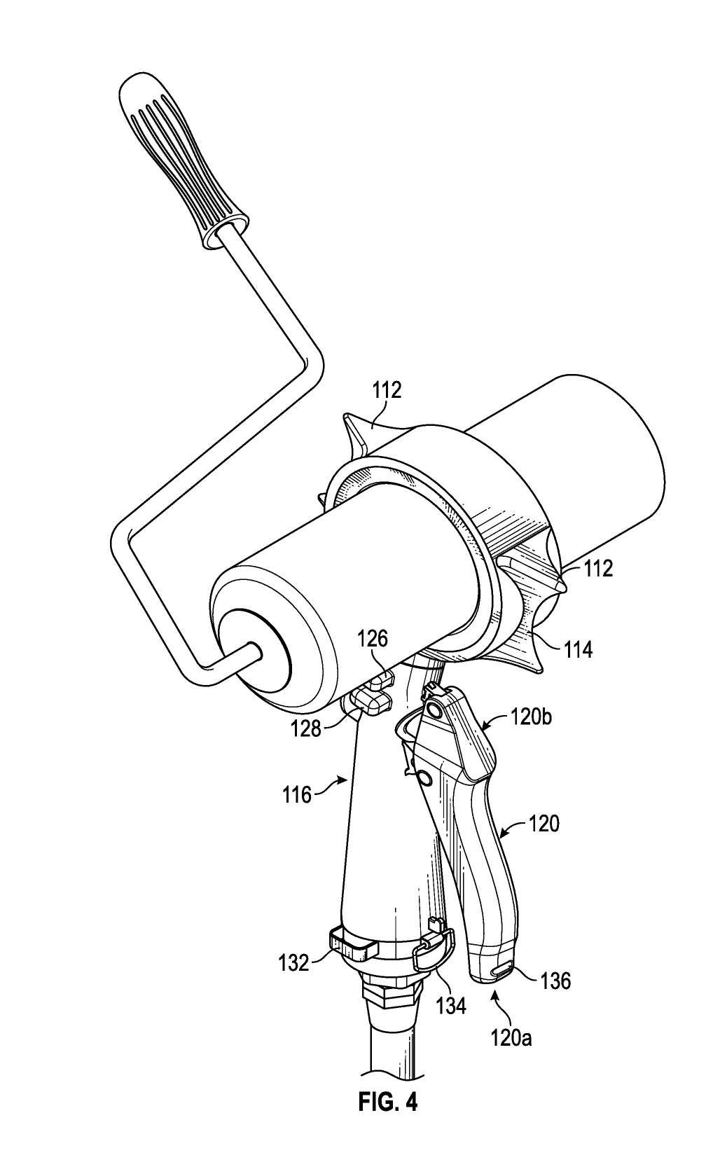

FIG. 1 illustrates a side view of a cleaning device 100, according to one embodiment. FIG. 2 illustrates of a side perspective view of a cleaning device, according to one embodiment. FIG. 3 is a cross sectional view of the cleaning device of FIG. 1. FIG. 4 illustrates a side perspective view of a cleaning device with a paint roller inserted therein, according to one embodiment. The following discussion refers interchangeably to FIGS. 1-4.

As shown, the cleaning device 100 may include a housing 102 having an outer ring wall 104 and an inner ring wall 106 that defines an opening 108 for receiving an object, such as paint roller, for cleaning. The inner ring wall 106 may include a plurality of holes 110 for propelling water, or other liquid, in a forward direction. According to one embodiment, the housing 102 may have a circular configuration and the plurality of holes 110 may be arranged in a circle. In other embodiments, the housing 102 may have other polygonal configurations.

According to one embodiment, the cleaning device 100 may include one or more scraping or grinding attachments 112 secured to, and extending outwardly from, the outer ring wall 104 to scrape or grind excess off the roller, or other device, prior to cleaning. The scrapping attachments 112 may be fixedly or removably secured to the outer ring wall 104 of the housing 102. An outer edge 114 of the scrapping attachment 112 may have a convex shape that matches the shape of a paint roller. To scrape the paint off the roller, the roller may be aligned with the outer edge 114 and the roller is either pulled upwards scraping the paint off the roller or the roller may be pushed downward scrapping excess paint off the roller prior to washing.

A handle member 116 may be integrally connected to, and extend perpendicularly outward from, the housing 102. The handle member 116 may include a hand grip portion 118 and a trigger portion 120, the trigger portion 120, having a bottom portion 120a and a top portion 120b, pivotally attached or coupled to the hand grip portion 118, having a bottom portion 118a and a top portion 118b. The trigger portion 120 may be adapted for movement between a no flow position, wherein the bottom portion 120a of an inner surface of the trigger portion 120 is spaced apart from the bottom portion 118a of the hand grip portion 118, and an open position wherein the bottom portion 120a of the inner surface of the trigger portion 120 is in contact with the bottom portion 120a of the hand grip portion 120. When in the open position, fluid flows to the housing 104 and propels out the plurality of holes 110. A flow control knob 122 may be located on the hand grip portion 118 for adjusting the amount and force of fluid that is propelled out of the plurality of holes 110 in the inner ring wall 106.

According to one embodiment the hand grip portion 118 may include internal threads 124 (See FIG. 3) for mating with external threads (not shown) on a hose (not shown). When the hose is turned on and the trigger portion 120 is in the open position, water flows into the housing 102 and propels out the plurality of holes 110 in the inner ring wall 106. (See FIG. 1) The water propels out the plurality of holes 110 onto an object inserted into the opening 108 of the housing. In one example the object may be a used paint roller and the water propelling out the plurality of holes 110 washes the paint off the paint roller. As the water is propelled out the plurality of holes 110, it is propelled into the paint roller soaking paint out of the roller. The device 100 may be placed in a bucket so that the paint and contaminated water are collected within the bucket and not splashed on the ground.

According to one embodiment, the hand grip portion 118 may include a protrusion 126 and a second protrusion 128 extending perpendicular outward from the top portion 118b of the hand grip portion 118. The first and second protrusions 126, 128 may be located parallel to each other in the same vertical plane and separated by a distance allowing for receipt of a handle of a paint can opener 130, for example. A receptacle 132 may be located at the bottom portion 118a of the hand grip portion 118 in the same vertical plane as the first and second protrusions 126, 128. A top handle portion of the opener 130 may be inserted between the first and second protrusions 126, 128 and a bottom handle portion of the opener 130 may be received within the receptacle 132 securing the opener 130 to the hand grip portion 118. In one example, the first and second protrusions 126, 128 may have a generally rectangular configuration.

According to one embodiment, a trigger locking bar 134 may be secured to the bottom portion 118a of the hand grip portion 118 and a locking groove 136 may be located in the bottom portion 120a of the trigger portion 120. The trigger locking bar 134 may be moveable between a locked position and an unlocked position. When in the locked position, the locking trigger bar 134 is received within the locking groove 136 locking the trigger portion 120 in an open position, as described above. When in the unlocked position, the locking trigger bar 134 is not secured within the locking groove 136 and the trigger portion 120 is in the no flow position, as described above.

One or more of the components and functions illustrated in FIGS. 1-4 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A cleaning device, comprising:
an outer ring wall;
an inner ring wall integrally connected to and located within the outer ring wall defining an opening for receiving an object;
a plurality of holes arranged in a circle on the inner ring wall for propelling liquid in a forward direction into the object; and
a handle member integrally connected to and extending perpendicularly outward from the outer ring wall, the handle member adapted to be matingly engaged with a hose, the hose supplying the liquid to the plurality of holes.

2. The device of claim 1, wherein the handle member comprises:
a hand grip portion; and
a trigger portion pivotally attached or coupled to the hand grip portion, the trigger portion adapted for movement between a no flow position and an open position.

3. The device of claim 2, wherein when the trigger portion is in the open position, fluid flows to the inner ring wall and propels out the plurality of holes.

4. The device of claim 1, further comprising a flow control knob connected to the hand grip portion for adjusting the amount and force of fluid that is propelled out of the plurality of holes.

5. The device of claim 1, wherein the object is a paint roller and the fluid is propelled into the paint roller soaking paint out of the roller.

6. The device of claim 1, further comprising one or more scraping attachments secured to, and extending outwardly from, the outer ring wall.

7. The device of claim 6, wherein the one or more scraping attachments has an outer edge having a convex configuration.

8. The device of claim 2, wherein the hand grip portion, having a top portion and an opposite bottom portion, comprises:
a first protrusion extending perpendicularly outward from the top portion;
a second protrusion extending perpendicularly outward from the top portion, the second protrusion located parallel to and below the first protrusion in the same vertical plane; and
a receptacle located at the bottom portion in the same vertical plane as the first and second protrusions.

9. The device of claim 8, wherein the first and second protrusions are separated by a distance and adapted to receive a first end of a second object; and wherein the receptacle is adapted to receive a second end of the second object.

10. The device of claim 9, wherein the second object is paint can opener.

11. The device of claim 8, further comprising:
a trigger locking bar secured to the bottom portion of the hand grip portion, the trigger locking bar moveable between a locked position and an unlocked position; and
a locking groove located at an end portion of the trigger portion;
wherein when in the locked position, the locking trigger bar is received within the locking groove locking the trigger portion in the open position; and
wherein when in the unlocked position the locking trigger bar is released from the locking groove and the trigger portion is in the no flow position.

12. A cleaning device, comprising:
an outer ring wall;
one or more scraping attachments secured to, and extending outwardly from, the outer ring wall;
an inner ring wall integrally connected to and located within the outer ring wall defining an opening for receiving an object;
a plurality of holes arranged in a circle on the inner ring wall for propelling liquid in a forward direction into the object;
a handle member integrally connected to and extending perpendicularly outward from the outer ring wall, the handle member adapted to be matingly engaged with a hose for supplying the liquid to the plurality of holes, the hand member comprises:
a hand grip portion; and
a trigger portion pivotally attached or coupled to the hand grip portion, the trigger portion adapted for movement between a no flow position and an open position; and
a flow control knob connected to the hand grip portion for adjusting the amount and force of fluid that is propelled out of the plurality of holes.

13. The device of claim 12, wherein when the trigger portion is in the open position, fluid flows to the inner ring wall and propels out the plurality of holes.

14. The device of claim 12, wherein the object is a paint roller and the fluid is propelled into the paint roller soaking paint out of the roller.

15. The device of claim 12, wherein the hand grip portion, having a top portion and an opposite bottom portion, comprises:
a first protrusion extending perpendicularly outward from the top portion;
a second protrusion extending perpendicularly outward from the top portion, the second protrusion located parallel to and below the first protrusion in the same vertical plane; and
a receptacle located at the bottom portion in the same vertical plane as the first and second protrusions.

16. The device of claim 15, wherein the first and second protrusions are separated by a distance and adapted to receive a first end of a second object; and wherein the receptacle is adapted to receive a second end of the second object.

17. The device of claim 16, wherein the second object is paint can opener.

18. The device of claim 15, further comprising:
a trigger locking bar secured to the bottom portion of the hand grip portion, the trigger locking bar moveable between a locked position and an unlocked position; and
a locking groove located at an end portion of the trigger portion;
wherein when in the locked position, the locking trigger bar is received within the locking groove locking the trigger portion in the open position; and
wherein when in the unlocked position the locking trigger bar is released from the locking groove and the trigger portion is in the no flow position.

19. A cleaning device, comprising:
an outer ring wall;
one or more scraping attachments secured to, and extending outwardly from, the outer ring wall;
an inner ring wall integrally connected to and located within the outer ring wall defining an opening for receiving an object;
a plurality of holes arranged in a circle on the inner ring wall for propelling liquid in a forward direction into the object;
a handle member integrally connected to and extending perpendicularly outward from the outer ring wall, the handle member adapted to be matingly engaged with a hose for supplying the liquid to the plurality of holes, the hand member comprises:
a hand grip portion, having a top portion and an opposite bottom portion, the hand grip portion comprising:
a first protrusion extending perpendicularly outward from the top portion;
a second protrusion extending perpendicularly outward from the top portion, the second protrusion located parallel to and below the first protrusion in the same vertical plane; and
a receptacle located at the bottom portion in the same vertical plane as the first and second protrusions; and
a trigger portion pivotally attached or coupled to the hand grip portion, the trigger portion adapted for movement between a no flow position and an open position; and
a flow control knob connected to the hand grip portion for adjusting the amount and force of fluid that is propelled out of the plurality of holes.

20. The device of claim 19, wherein the first and second protrusions are separated by a distance and adapted to receive a first end of a second object; and wherein the receptacle is adapted to receive a second end of the second object.
